(19) United States
(12) Patent Application Publication
(10) Pub. No.: US 2006/0226632 A1
(43) Pub. Date: Oct. 12, 2006

(54) BICYCLE

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/907,627

(22) Filed: Apr. 8, 2005

(51) Int. Cl. B62K 21/00

(52) U.S. Cl. 280/288.4; 280/279

(57) ABSTRACT

A bicycle includes a head tube, an optional device and two screws. Two screw holes are defined in the head tube. The optional device may be a mark plate, a light, a holder for bottle or a bracket for a bag, case or basket. The screws are driven into the screw holes in order to attach the optional device to the head tube in a firm and detachable manner.

### BACKGROUND OF INVENTION

1. Field of Invention

The present invention relates to a bicycle and, more particularly, to a bicycle with a head tube adapted for carrying an optional device.

2. Related Prior Art

Referring to FIG. 1, a conventional head tube 1 of a bicycle is shown. A mark plate 2 is secured to the head tube 1 by means of rivets 3. The mark plate 2 is used for identification of the material, brand and/or class of such a bicycle. However, as the mark plate 2 is secured to the head tube 1, an additional mount must be attached to the head tube 1 in order to support a bracket, light or any other optional device. Inevitably, the cost for using an optional device is increased. Furthermore, the process of installing an optional device is troublesome. Moreover, such a mount and such an optional device can easily be shaken and loosened on the head tube 1. It is neither economic nor practical to use the head tube 1 and such an optional device.

The present invention is therefore intended to obviate or at least alleviate the problems encountered in prior art.

### SUMMARY OF INVENTION

According to the present invention, a bicycle includes a head tube, an optional device and two screws. Two screw holes are defined in the head tube. The screws are driven into the screw holes in order to attach the optional device to the head tube in a firm and detachable manner.

An advantage of the present invention is the easy attachment and detachment of the optional device because the fasteners can be engaged with and disengaged from the connective portions.

Another advantage of the present invention is the low cost of using the optional device because of the direct attachment of the optional device to the flat portion head tube.

Another advantage of the present invention is the firm attachment of the optional device because of the direct attachment of the optional device to the flat portion head tube.

Other advantages and novel features of the invention will become more apparent from the following detailed description in conjunction with the attached drawings.

### BRIEF DESCRIPTION OF DRAWINGS

The present invention will be described through detailed illustration of embodiments referring to the drawings.

FIG. 1 is a perspective partial view of a conventional bicycle.

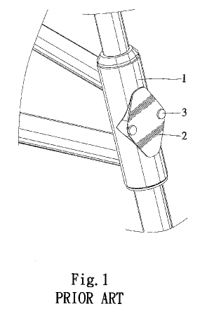

FIG. 2 is a perspective view of a bicycle according to a first embodiment of the present invention.

FIG. 3 is a perspective partial view of the bicycle shown in FIG. 1.

FIG. 4 is an exploded view of the bicycle shown in FIG. 3.

FIG. 5 is a side view of a bicycle according to a second embodiment of the present invention.

FIG. 6 is a side view of a bicycle according to a third embodiment of the present invention.

FIG. 7 is a side view of a bicycle according to a fourth embodiment of the present invention.

FIG. 8 is a side view of a bicycle according to a fifth embodiment of the present invention.

### DETAILED DESCRIPTION OF EMBODIMENTS

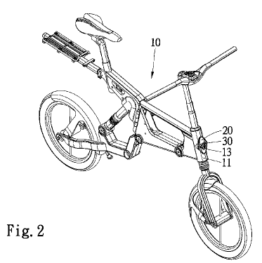

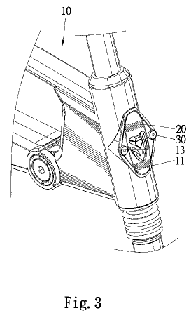

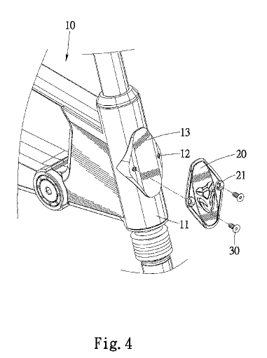

Referring to FIGS. 2 through 4, according to a first embodiment of the present invention, a bicycle 10 includes a head tube 11. The head tube 11 includes a flat portion 13 formed thereon. Two connective portions 12 are formed on or in the flat portion 13. As shown, the connective portions 12 are screw holes defined in the flat portion 13.

An optional device 20 can be mounted on the flat portion 13. The optional device 20 defines two apertures 21 corresponding to the connective portions 12. As shown, the optional device 20 is a mark plate that is attached flush to the flat portion 13.

Two fasteners 30 can be inserted through the apertures 21 and then engaged with the connective portions 12 in order to install the optional device 20 on the flat portion 13. As shown, the fasteners 30 are screws driven into the screw holes 12.

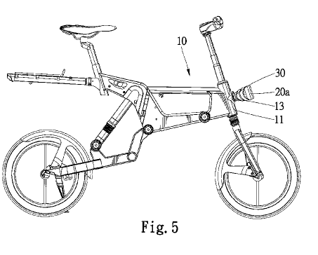

FIG. 5 shows a bicycle according to a second embodiment of the present invention. The second embodiment is similar to the first embodiment except for including an optional device 20a instead of the optional device 20. The optional device 20a is a light.

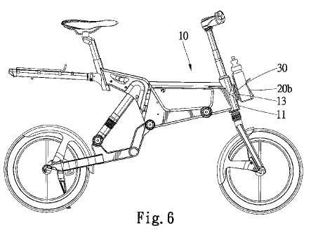

FIG. 6 shows a bicycle according to a third embodiment of the present invention. The third embodiment is similar to the first embodiment but for including an optional device 20b instead of the optional device 20. The optional device 20b is a bottle holder.

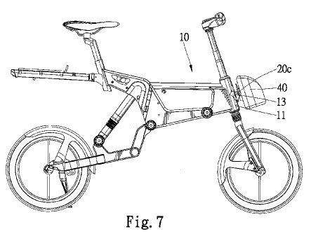

FIG. 7 shows a bicycle according to a fourth embodiment of the present invention. The fourth embodiment is similar to the first embodiment except for including an optional device 20c instead of the optional device 20. The optional device 20c is a bracket for supporting a multi-functional bag or case 40.

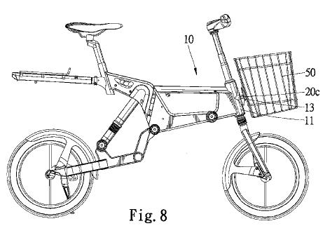

FIG. 8 shows a bicycle according to a fifth embodiment of the present invention. The fifth embodiment is similar to the fourth embodiment except that the optional device 20c supports a basket 50 instead of the multi-functional bag or case 40.

In an embodiment, the connective portions 12 may be screws formed on the flat portion 13 and inserted through the apertures 21, and the fasteners 30 may be nuts engaged with the screws.

The bicycle of the present invention includes several advantageous features. Firstly, the fasteners 30 can be engaged with and disengaged from the connective portions 12. Hence, the attachment and detachment of the mark plate 20, the light 20a, the bottle holder 20b and the bracket 20c is easy. Therefore, the attachment of the mark plate 20, the light 20a, the bottle holder 20b and the bracket 20c is suitable for DIY by customers. Secondly, the cost is low because the mark plate 20, the light 20a, the bottle holder 20b and the bracket 20c are directly attached to the flat portion 13. Thirdly, the attachment is firm because the mark plate 20, the light 20a, the bottle holder 20b and the bracket 20c are directly attached to the flat portion 13.

The present invention has been described through detailed illustration of the embodiments. Those skilled in the art can derive variations from the embodiments without departing from the scope of the present invention. Therefore, the embodiments shall not limit the scope of the present invention defined in the claims.

What is claimed is:

1. A bicycle comprising a head tube, two screw holes defined in the head tube, an optional device and two screws driven into the screw holes for attaching the optional device to the head tube in a firm and detachable manner.

2. The bicycle according to claim 1 comprising a flat portion formed on the head tube, the screw holes are defined in the flat portion.

3. The bicycle according to claim 1 wherein the optional device comprises two apertures defined therein corresponding to the screw holes.

4. The bicycle according to claim 3 wherein the screws are driven into the screw holes through the apertures of the optional device.

5. The bicycle according to claim 1 wherein the optional device is a mark plate.

6. The bicycle according to claim 1 wherein the optional device is a light.

7. The bicycle according to claim 1 wherein the optional device is a holder for bottles.

8. The bicycle according to claim 1 wherein the optional device is a bracket.

9. The bicycle according to claim 8 comprising a bag supported by means of the bracket.

10. The bicycle according to claim 8 comprising a basket supported by means of the bracket.
